(19) United States
(12) Patent Application Publication
(10) Pub. No.: US 2026/0201190 A1
(43) Pub. Date: Jul. 16, 2026

(54) INKJET INK WITH IMPROVED SHELF LIFE

(71) Applicant: XEIKON MANUFACTURING N.V., Lier (BE)

(72) Inventors: Werner Jozef Johan OP DE BEECK, Lier (BE); Lode Erik Dries DEPREZ, Lier (BE); Wouter Jeroom Maria VAN GAENS, Lier (BE); Geert Gaston Paul DEROOVER, Lier (BE)

(73) Assignee: XEIKON MANUFACTURING N.V., Lier (BE)

(21) Appl. No.: 19/135,696

(22) PCT Filed: Dec. 8, 2023
(86) PCT No.: PCT/EP2023/084940

§ 371 Date: Jun. 4, 2025

(30) Foreign Application Priority Data
Dec. 8, 2022 (NL) 2033694

(51) Int. Cl. C09D 11/36; C09D 11/322; C09D 11/38

(52) U.S. Cl. CPC C09D 11/36; C09D 11/322; C09D 11/38

(57) ABSTRACT

An aqueous inkjet ink composition (IC) for forming an image on a substrate, said composition comprising a pigment (P), an organic solvent (OS) and further comprises: a polymeric binder (B), at least 0.65 wt % of first surfactant (S1), said first surfactant being a silicone surfactant with a siloxane-backbone (BB) comprising 3 Si atoms and wherein a polyether side chain (SC) is linked to the siloxane backbone via a carbon chain linking group (L) with 2 to 4 carbon atoms; wherein the polyether side chain comprises 2 to 5, preferably 3 or 4 ethylene oxide units (EO); wherein a dry weight ratio of the first surfactant (S1)/the polymeric binder (B) is 0.22 or higher, preferably 0.25 or higher, more preferably 0.3 or higher.

The present invention relates to inkjet inks for forming an image on a substrate, in particular aqueous inks or waterbased inks, with improved shelf life. These inks can be used to print on substrates such as uncoated or coated paper, uncoated or coated corrugated boards or polymeric film substrates.

### BACKGROUND ART

When printing aqueous inks with industrial single pass inkjet, achieving a decent spreading of the ink droplets is difficult, in particular when printing with aqueous inks on apolar substrates like coated paper substrates or polymeric film substrates and even more so when printing without the use of primers or other substrate surface modifying methods. Many of paper substrates are given specific properties such as water resistance or water repellency, ink holdout, smoothness, gloss etc. However, this typically makes it more challenging to ensure that waterbased aqueous ink droplets spread out sufficiently over the substrate. Hence, achieving a good print image quality on such substrates can be difficult, in particular in single pass industrial printing. Similarly, insufficient ink wetting is often observed when printing waterbased inks on e.g. plain untreated polymeric films. Approaches have been made to address the above.

A first approach is the use of “a primer” to improve the aqueous ink receptibility of the substrate. This primer would be applied on the substrate before the ink. However, the use of primers is not always desirable as it brings extra cost and complexity. Also, the use of primer is not always sufficient to achieve the desirable ink droplet spread out (also called dotgain) on all types of substrates. Furthermore, not all printers are provided with a primer station because this adds complexity and cost, so using a primer or any other pretreatment liquid before the ink is applied is not always an option.

A second approach is the use of suitable surfactants within the aqueous ink formulation. This can be done instead of a primer (or in addition to a primer) to achieve decent ink spreading on substrates. One example of such surfactants is a “fluoro-surfactant” which can be used to make the ink surface tension compatible with the surface energy of the substrate to print on. However, using fluoro-surfactants are prohibited when printing on packaging that will be in direct or indirect contact with food stuff. Another example of such a surfactant is an “alkoxylated siloxane-based surfactant”, such as an “ethoxylated siloxane surfactant”, these can be as efficient as the fluoro-surfactants to lower the static surface tension of the ink and to improve the substrate compatibility.

However, the siloxane surfactants have the disadvantage of a high sensitivity towards hydrolysis in an aqueous environment, i.e. an environment with water. This is especially the case in an alkaline or acidic environment. As most chemical processes the hydrolysis is further accelerated with increased temperature. The sensitivity is even more pronounced for ethoxylated trisiloxane-based surfactants, having a trisiloxane backbone with shorter side chains. For this side chain ethylene oxide chains are often used to give the molecule its solubility in water. It is believed that short side chain(s) cause the silicone backbone to be more accessible to the water within the aqueous environment, hence resulting in degradation of the backbone under prolonged contact with water since the siloxanebonds (—Si—O—) therein can be hydrolysed. The hydrolysis results in a loss of surfactant functionality due to decomposition over time. This is undesirable in the field since it greatly impacts the shelf life of an aqueous ink.

An approach to address the hydrolysis problem is to specifically design silicone surfactants in a way to protect the backbone and make it more resistant to hydrolysis. However, these surfactants can be difficult to synthesize and/or are typically not readily available as commercial products so the accessibility is low. Furthermore, in general the cost increases significantly when using tailor made chemicals. Moreover, the tailor made chemicals such as ethoxylated silicone surfactants may be optimized to address the hydrolysis problem but may not result in the best possible ink spreading, especially in an industrial single pass technology printing at high speeds where the time for ink spreading is very low.

It is thus beneficial to provide decent shelf-life to the ink and to increase the length of time that the ink can be stored without losing image print quality.

Hence, it is an object to provide an ink with an excellent shelf life, while printing with said ink results in a high print quality with minimal intercolor bleeding and reduced mottle, while simultaneously providing an ink that attaches decently to the substrate.

### SUMMARY OF THE INVENTION

Thereto, a first aspect herein provides an aqueous inkjet ink composition for forming an image on a substrate, said composition comprising a pigment (P), an organic solvent (OS) and further comprises: a polymeric binder (B), at least 0.65 wt % of first surfactant (S1), said first surfactant, more in particular, being represented by the most predominant structure present therein that is a silicone surfactant with a siloxane-backbone (BB) comprising 3 Si atoms, in particular a trisiloxane-backbone (BB), and wherein a polyether side chain (SC) is linked to the siloxane backbone via a carbon chain linking group (L) with 2 to 4 carbon atoms; wherein the polyether side chain comprises 2 to 5, preferably 3 or 4 ethylene oxide units (EO), in particular not more than 5 ethylene oxide units (EO), more in particular wherein the polyether side chain comprises at least 2 and at most 5 ethylene oxide units (EO); wherein a dry weight ratio of the first surfactant (S1)/the polymeric binder (B) is 0.22 or higher, preferably 0.25 higher, or more preferably 0.3 or higher.

Inventive insight has provided that by combining the (hydrolysis sensitive) siloxane-based surfactants with one or more polymeric binders, one can avoid, minimize or slow down the hydrolysis of siloxane surfactants, including the hydrolysis sensitive siloxane-based surfactants mentioned hereinbefore. Testing has shown that when the binders are combined with this type of surfactant chemistry, preferably trisiloxane chemistry (which indicates 3 Si atoms in the backbone), in an appropriate amount and in a desired ratio one can obtain excellent ink substrate wetting and very low levels of mottle for overlays of multiple process colors during fast industrial single pass printing.

The surfactant chemistry of the first surfactant (S1) as described herein further indicates that its side chain has a certain length which allows for improved ink properties, in particular the polyether side chain has 2 to 5 ethylene oxide units (EO), and hence not more than 5.

Insights have provided in that improved surprising properties can be achieved by including the first surfactant (S1) in the defined amount and S1/B ratio and wherein the surfactant (S1) is a silicone surfactant with a trisiloxane-backbone (BB) with a polyether sidechain (SC) that has 2 to at most 5 ethylene oxide units (EO), preferably 2 to at most 4 ethylene oxide units (EO).

Moreover, this excellent image quality can even be obtained after the ink has been on the shelf over a prolonged period of time. Indeed, the mottle of ink compositions with combinations of the specified surfactant, preferably a trisiloxane, with binders is very acceptable for even long shelf times.

In contrast, it was found that inks with the same preferred trisiloxane surfactants but without binders deteriorate quickly and result in non-acceptable mottle for the printed image after a relatively short shelf life. Furthermore, due to the presence of a binder, the printed surface is durable and scratch resistant. Compositions without binder are known to be less prone to inkjet head clogging and generally give more ink spreading but have the drawback of being less durable and in some cases more intercolor bleeding is observed. The binder in the ink composition is responsible for a better attachment of the ink to the substrate. Without a binder in the ink composition, the ink can easily be scratched off the substrate. Additionally, drying speed properties are improved when a binder is added to the ink composition.

In a preferred embodiment, the aqueous ink composition comprises at least one trisiloxane-based surfactant, hereinafter also referred to as the first surfactant (S1), said first surfactant (S1) being a silicone surfactant with a siloxane-backbone (BB) comprising 3 Si atoms, in particular a trisiloxane-backbone (BB) with 3 Si atoms, and wherein a polyether side chain (SC) is linked to the siloxane backbone via a carbon chain linking group (L) with 2 to 4 carbon atoms, said polyether side chain comprising 2 to 5 ethylene oxide units (EO), in particular at most 5 ethylene oxide units (EO).

In a preferred embodiment, said first surfactant (S1) has a trisiloxane-structure represented by formula I:

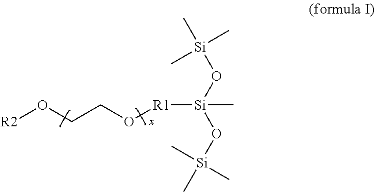

In the formula, R1 represents the carbon chain linking group (L) and has 2 to 4 carbon atoms, preferably 2 or 3 carbon atoms, more preferably 3 carbon atoms. Further, in the formula, R2 functions as an end group of the side chain. R2 represents a hydrogen atom or a hydrocarbon group having 1 to 4 carbon atoms, preferably a hydrogen atom. Further, x is between 2 and 5, preferably 3 or 4. By choosing x as such, decent surfactant functionality could be given and while the surfactant could migrate rapidly through the ink composition to deliver its functionality where needed. Furthermore, by including between 2 and 5, preferably 3 or 4 ethylene oxide units EO, one can improve interaction with the aqueous medium of the ink due to an improved solubility and thus surfactant activity. More preferably, the carbon chain of R1 is a linear carbon chain, preferably a saturated linear chain with 3 carbon atoms. Most preferably, R1 is a saturated linear carbon chain with 3 carbon atoms and x is 4 and R2 is H.

The trisiloxane-structure of the first surfactant S1 as described herein, in particular the structure according to formula I, is to be understood as the structure in representing the surfactant as it would be commercially presented, and corresponds to its structurally most dominant fraction. Namely, the S1 surfactant predominantly consists of a structurally dominant faction as described in the context of S1, in particular as represented by formula 1, with potential variations thereof to a lesser extent. Hence, the S1 surfactant should be included in the earlier described amount of and ratio wherein the wt % and ratio is calculated with the surfactant as it would be available on market (some variations thereof may be present therein). Preferably, in its pure form, the structure according to formula 1 is reliably detectable within the overall ink composition when assessed through LMCS (Liquid Mass Chromatography Spectroscopy). When measured via LMCS, the structure according formula I in its pure form is preferably present within the overall ink composition in an amount of at least 0.15 wt %, preferably at least 0.2 wt %, more preferably at least 0.23 wt % and even more preferably at least 0.3 wt %.

The LCMS measurement (Liquid Chromatography-Mass Spectrometry) protocol is preferably performed on a 1260 Infinity II/Quadrupole 6120 (Agilent) LC/MS equipment using a Poroshell 120 EC-C18 (Agilent) as LC column with the following elution mixture gradient at a flow rate of 1 ml/min:

| Time | % | % water (5 mM ammonium |
|---|---|---|
| (min) | Acetonitril | acetate) |
| 0 | 10 | 90 |
| 12 | 100 | 0 |
| 15 | 10 | 90 |

In performing LCMS analysis the injection volume and surfactant concentration should be optimized to give the highest peak resolution. With a preferred silicone surfactant component as herein provided, the different siloxane surfactant molecules with different alkoxyether side chains lengths but with the same number of siloxane units are expected to elute at the same time. Surfactant with different siloxane lengths however elute at different times and should be sufficiently resolved using the procedure described above. Using the resolved elution peaks and the integrated number of detector counts under the elution peak one can establish the relative weight percentage of for example all trisiloxane surfactants in the composition. Additionally, for any resolved elution peak of a specific siloxane length, one can then also generate the m/z spectrum using the detector counts for each trisiloxane surfactant of different side chain composition. The number of detector counts for each m/z (since every surfactant molecule corresponds with a unique m/z) versus the total amount of counts of all detected silicone surfactants under the same elution peak gives the weight % of any individual surfactant molecule. Even when elution peaks of different siloxane chain lengths still partially overlap one can still use the detector counts as a function of m/z to determine any relative weight % because every surfactant molecule corresponds with a unique m/z.

As an example, analysis of Byk347 by the inventors indicate that 70 wt. % of the total component is a trisiloxane, while 30 wt % is a tetrasiloxane. Furthermore, of the 70 wt % trisiloxane, 75% comprises 2-5 PEO. Of the 70 wt % trisiloxane, 45% comprises 3-4 PEO. The skilled person will thus conclude that Byk347 constitutes a trisiloxane with 3-4 PEO, and in a lesser way also including 2 and 5 PEO.

Hence, preferably, the first surfactant (S1) as described herein predominantly comprises a surfactant having a structure according to formula I and may include variations thereof in a lesser extent. Generally applicable herein, it is preferred that as seen within the overall ink composition, that a faction of at least 0.15 wt %, preferably at least 0.2 wt %, more preferably 0.23 wt %, even more preferably at least 0.3 wt % of the overall ink composition represents a faction of purely surfactant structure(s) as measured via LCMS analysis, wherein said purely surfactant structures have a structure according to the first surfactant (S1) as described herein, in particular a structure according to formula I as described herein. Thereto, the at least one first surfactant (S1) includes most predominantly a surfactant structure having a trisiloxane-backbone (BB) with 3 Si atoms, and wherein a polyether side chain (SC) is linked to the siloxane backbone via a carbon chain linking group (L) with 2 to 4 carbon atoms; wherein the polyether side chain comprises 2 to at most 5, preferably 3 or 4 ethylene oxide units (EO). Preferably, the most predominantly surfactant structure of the first surfactant is present within the overall ink composition in an amount of at least 0.15 wt %, preferably at least 0.2 wt % more preferably at least 0.23 wt % and even more preferably at least 0.3 wt %, wherein the presence of the surfactant structure is determined via LCMS. In a preferred embodiment, the first surfactant has a molecular weight lower than 600 g/mol, more preferably lower than 530 g/mol, most preferably lower than 500 g/mol, such as 457 g/mol. This way, the surfactant can move quickly through the ink composition and deliver a desired wettability performance in a rapid manner.

In a further embodiment, the composition comprises an additional silicone surfactant (S′) which is different from the first surfactant (S1). The additional surfactant is preferably a silicone surfactant. More preferably a silicone surfactant with a (longer) side chain that has a higher molecular weight than the side chain of the first surfactant, for example as a result of more ethylene oxide units and/or propylene oxide units present in the side chain. Adding such a second silicone surfactant (S′) in addition to the first surfactant (S1) and the polymeric binder (B), may further increase the print quality. More preferably, the additional surfactant (S′) is a silicone surfactant with
a siloxane-backbone (BB) comprising 3-5 Si atoms and wherein
a polyether side chain (SC) is linked to the siloxane backbone via a carbon chain linking group (L) with 2 to 4 carbon atoms; wherein the polyether side chain comprises 6-15 ethylene oxide units (EO), preferably 7-14 ethylene oxide units. By having both the first surfactant (S1) as described herein and the additional surfactant (S′) present, the jettability and print and image quality can further be improved. In an embodiment, the polyether side chain (SC) of the additional surfactant (S′) is free from propylene oxide units (PO).

In an embodiment, the first surfactant (S1) has a molecular weight of lower than 600 g/mol and the additional surfactant (S′) has a molecular weight higher than 540 g/mol, preferably higher than 600 g/mol, more preferably between 600 and 1500 g/mol, even more preferably between 600 and 1000 g/mol.

The molecular weight of the additional surfactant (S′) is preferably larger than the molecular weight of the first surfactant (S1). This way, a desired surfactant functionality can be obtained which benefits print quality. The difference of molecular weights between the first surfactant (S1) and the additional surfactant (S′) may be at least 40 g/mol, preferably at least 50 g/mol. This way, an overall good print quality can be obtained.

In a particular embodiment, the binder (B) is present in the ink in an amount of at least 0.5 wt % and wherein the first surfactant (S1) has a molecular weight of lower than 600 g/mol. Such inclusion of components within the ink composition allows for improved ink properties.

In a particular embodiment, the ink composition further comprises a non-siloxane surfactant (S2). By including the non-siloxane surfactant in addition to the first siloxane surfactant (S1), one can improve both jettability of the ink and image quality.

In an embodiment, the non-siloxane surfactant (S2) is an ethoxylated surfactant, more preferably an ethoxylated acetylenic diol, even more preferably an ethoxylated acetylenic diol with a backbone of 10 or 12 carbons, most preferably represented by the following formula II wherein m+n is between 4 to 12, m is 1 or more and n is 1 or more, so as to improve printing reliability.

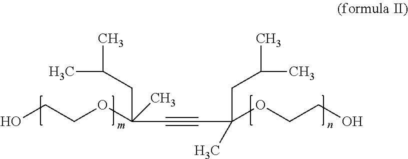

In an embodiment, a weight ratio of first surfactant (S1)/total amount of surfactants within the ink composition (IC) is between 0.1-1.0, preferably between 0.2-1.0, more preferably between 0.2-0.7. The preferred ratios achieved good ink qualities with acceptable degrees of mottle and a desired wetting performance on the substrate. The total amount of surfactants within the ink composition can for example be the sum of the first surfactant (S1), with the additional surfactant (S′) and/or the non-siloxane surfactant (S2), if present.

In an embodiment, the first surfactant (S1) has a weight concentration within the ink composition (IC) of at most 2 wt %, preferably at most 1.8 wt %, more preferably at most 1.5 wt %. This way, one can (further) avoid print quality issues such as intercolor bleeding and feathering.

In an embodiment, the ink composition (IC) has a static surface tension below 26 mN·m as measured at 10 s by bubble pressure tensiometer (Pro Line T15, SITA Messtechnik GmbH).

In an embodiment, the organic solvent (OS) comprises a water-soluble solvent having a boiling point of 180° C. or higher, preferably chosen from the group of polyols such as glycerol, 1,2 propane diol or glycol ethers such as diethylene glycol butyl ether or a combination thereof. The term “water-soluble” can be understood as that the organic solvent is miscible with water at room temperature. The room temperature is taken to be in the range 20 to 25° C. and is typically 23° C.

In an embodiment, the polymeric binder (B) is chosen from an anionic polymeric binder, a cationic polymeric binder, or a non-ionic polymeric binder. The polymer can be present in a dissolved state or as colloidal microparticles. In a preferred embodiment, polymeric binder (B) is an acrylic, vinyl, styrene, olefinic or polyurethane based polymeric binder, preferably an acrylic-based polymer. Surprisingly, polymeric binders could stabilize the siloxane-based surfactants (S1, S′) and cause the ink composition to have an improved shelf life. Multiple polymeric binders were evaluated and the effect seems independent of the binder chemistry or composition. Commercial examples of polymeric binders (B) include Joncryl J8050E (BASF), Lubrijet T340 (Lubrizol), Neocryl D2101 (DSM).

In an embodiment, the polymeric binder (B) has a dry weight concentration within the ink composition (IC) between 0.5-12 wt %, preferably between 0.7-8 wt %, more preferably between 1-5 wt %. This way, the first siloxane surfactant (S1) can be stabilized and the degradation thereof over time can be minimized or avoided.

In an embodiment, a dry weight ratio of the first surfactant (S1)/polymeric binder (B) within the ink composition (IC) is 0.22 or higher, preferably 0.25 or higher, more preferably 0.3 or higher so as to achieve a desired level of ink droplet spreading and wetting, sufficiently reducing the level of mottle and achieving a good drying speed of the ink.

A further aspect relates to the use of the ink composition to print on a corrugated board, preferably a coated corrugated board. The latter typically being a challenging substrate to print on. However, surprisingly, the ink composition as described herein could achieve a good print quality thereon.

Additionally, a further aspect relates to the use of the ink composition to print on a polymeric film, such as a polypropylene (PP), polyethylene (PE), poly amide or polyethylene terephthalate (PET) film and even aluminum based thin film substrates such as typically used in packaging industry.

A further aspect relates to a process for manufacturing an ink composition (IC), said process comprising the steps of:
providing a mixture comprising a pigment (P), an organic solvent (OS) and water (W); adding a polymeric binder (B) and a first surfactant (S1) to the mixture, wherein the first surfactant (S1) has a weight concentration of at least 0.65 wt % and wherein a dry weight ratio of the first surfactant (S1)/polymeric binder (B) is 0.22 or higher;
said first surfactant (S1) being a silicone surfactant with a siloxane-backbone (BB) comprising 3 Si atoms, in particular a trisiloxane-backbone (BB) with 3 Si atoms, and wherein a polyether side chain (SC) is linked to the siloxane backbone via a carbon chain linking group (L) with 2 to 4 carbon atoms, said polyether side chain preferably comprising 2 to 5 ethylene oxide units (EO), more preferably 3 to 5 ethylene oxide units (EO), even more preferably at most 5 ethylene oxide units (EO). In particular, said polyether side chain comprises 2 to at most 5 ethylene oxide units (EO) or with other words, not more than 5 ethylene oxide units (EO).

There is no limitation regarding the order of addition of the different in ingredients.

Herein, the same named features/components can have one or more features as described in connection to the same named features/components above and further below.

A further aspect relates to a set for inkjet printing, said set comprising the ink composition (IC) as described herein and a pretreatment liquid (P) for forming a primer layer. The primer layer can, if needed, further improve ink receptibility. A primer is especially suitable for coated paper substrates or non-absorbing polymeric film materials, such as poly ethylene (PE), poly amide or polyethylene terephthalate (PET) film and even aluminum based thin film substrates such as typically used in packaging industry. Other methods for improving the wettability such as corona or flame treatment may also be used.

In an embodiment, the pretreatment liquid (P) comprises at least one aggregating agent of the group: multivalent metal salt, organic acid and/or cationic polymer.

An aspect relates to the use a polymeric binder (B) within an inkjet composition (IC) comprising siloxane surfactants, in particular trisiloxane surfactants as herein provided, said use comprising the improvement of the shelf life of the siloxane surfactants.

The elements specified in the context of the composition are equally applicable and efficacious within the context of the process, and conversely, the procedural steps are compatible with the components articulated in the context of the composition.

### DETAILED DESCRIPTION

The skilled person will appreciate on the basis the detailed description that the invention can be embodied in different ways and on the basis of different principles. The invention is not limited to the described embodiments and examples are purely illustrative and serve only to increase understanding of the invention. The invention will not therefore be limited to the embodiments described herein, but is defined in the claims.

### Inkjet Printing

Inkjet printing is a known technique for computer printing that recreates a digital image by propelling droplets of ink onto substrates, e.g. paper and plastic substrates. It may be challenging to print (polar) aqueous ink compositions on (apolar) substrates and achieve high image quality, hence the provision of the composition with the binder and the surfactant(s) having features as described herein.

### Ink Composition (IC)

Aqueous inks can be broadly classified into “pigment dispersion inks” and “dye inks”. The term “aqueous” refers to an environment containing water molecules (H₂O).

In recent years, demand has been growing for pigment dispersion inks, which exhibit excellent color development and solvent, gas and (UV-)light resistance and the like. On the other hand, in the case of pigment aqueous dispersion inks, because the pigment is insoluble in water, in many cases, satisfactory pigment dispersibility is hard or cannot be achieved. Accordingly, in order to maintain favorable pigment dispersibility within aqueous inks, pigment “dispersing resins” have been used to achieve better dispersion stability of the pigment in water. These pigments are also considered better performing towards migration into food. The use of a colorant in inks as described above is the most essential form of a water-based ink.

Aqueous inks used in inkjet printing methods often also contain an organic water-soluble solvent having a high boiling point and favorable solubility in water to prevent drying of the ink at the nozzles. This type of solvent is regarded as “a humectant” in the aqueous ink.

Aqueous inks used in ink-jet printing methods may also contain one or more surfactants. Finally, the aqueous ink composition may also contain various types of additives such as anti-foaming agents, thickeners, binders and preservatives as required. Adding these types of additives to the aqueous ink composition enables the composition to be used more favorably as an inkjet ink. Other possible primer components include biocides, anti-foaming agents, slip additives (e.g. wax particles), corrosion inhibitors, and the like. It is preferred that the ink jet inks are optimized for maintaining optimal jetting behavior (surface tension, viscosity, particle size) and excellent storage stability.

### Pigment(s) (P)

In exemplary embodiments, the pigment P is an organic pigment, optionally comprising a metal atom complexed with an organic component of the organic pigment. In exemplary embodiments, the pigment P is an inorganic pigment optionally comprising a metal oxide. In a particular exemplary embodiment, the magenta pigment is a quinacridone pigment selected from Pigment Red 122, Pigment Violet 19 and/or Pigment Red 202, and/or the magenta pigment is Pigment Red 57:1, and/or wherein the cyan pigment is Pigment Blue 15:3, Pigment blue 15.4, and/or pigment blue 15.6 and/or wherein the yellow pigment is selected from Pigment Yellow 155, Pigment Yellow 74, and/or pigment yellow 180 and/or wherein the black pigment is a carbon black, preferably Pigment Black 7. A pigment is preferably used from the viewpoints of offering excellent water resistance, light resistance, weather resistance and gas resistance or the like. Examples of pigments that may be used in the present invention include conventional organic pigments and inorganic pigments.

The pigment may e.g. be chosen from those disclosed by HERBST, W., et al. Industrial Organic Pigments, Production, Properties, Applications. 2nd edition. vch, 1997. The pigment particles in the pigmented inkjet ink should be sufficiently small to permit free flow of the ink through the inkjet printing device, especially at the ejecting nozzles. It is also desirable to use small particles for maximum color strength and to slow down sedimentation.

The average particle size of the pigment in the pigmented inkjet ink should be between 5 nm and 1 μm, particularly preferably between 5 nm and 500 nm and most preferably between 30 nm and 300 nm. Larger pigment particle sizes may be used.

The pigment is used in the pigmented ink-jet ink in an amount of 0.1 to 30 wt-%, preferably 1 to 10 wt-% based on the total weight of the pigmented inkjet ink.

Examples of cyan pigments that can be used in the present invention include C.I. Pigment Blue 1, 2, 3, 15:3, 15:4, 15:6, 16 and 22, and C.I. Vat Blue 4 and 6. These cyan pigments may be used individually, or a combination of two or more pigments may be used.

Examples of magenta pigments that can be used in the present invention include C.I. Pigment Red 5, 7, 12, 22, 23, 31, 48 (Ca), 48 (Mn), 49, 52, 53, 57 (Ca), 57:1, 112 and 122; Quinacridone solid solutions 146, 147, 150, 185, 238, 242, 254, 255, 266 and 269, and C.I. Pigment Violet 19, 23, 29, 30, 37, 40, 43 and 50. Quinacridone mixed-crystal pigments can also be used.

Examples of yellow pigments that can be used in the present invention include C.I. Pigment Yellow 10, 11, 12, 13, 14, 17, 20, 24, 74, 83, 86, 93, 94, 95, 109, 110, 117, 120, 125, 128, 137, 138, 139, 147, 148, 150, 151, 154, 166, 168, 180, 185 and 213.

Other organic pigments can be used to enhance the color gamut like C.I. Pigment Green 36, and 7, Pigment Violet 23, Pigment Orange 34, 43 and 64.

Examples of black pigments that can be used in the present invention include organic pigments such as aniline black, Lumogen black and azomethine black, and inorganic pigments such as carbon black and iron oxide. Further, a plurality of color pigments such as the aforementioned yellow pigments, magenta pigments and cyan pigments may be mixed together and used as a black pigment. There are no particular limitations on the inorganic pigments that may be used in the present invention. Examples of inorganic pigments may also include different metal oxides.

Additionally, the inorganic pigment can include “a white pigment” such as titanium dioxide (anatase, brookite and rutile) which is for example commercially available from KRONOS (e.g. grade 2044, 2047) or as metal oxide coated titanium dioxides (e.g. R700 E.I. DuPont de Nemours), or other inorganic pigments such as zinc oxide and iron oxide. It was further found that titanium dioxide had anti-bacterial effects on the ink composition.

Examples of carbon black pigments that can be used in the present invention include carbon blacks produced using the furnace method or the channel method.

Examples of commercial products are listed below, and any of these products can be used favorably. Specific examples of carbon black include No. 33, 40, 45, 52, 900, 2200B, 2300, MA7, MA8 and MCF88 (all manufactured by Mitsubishi Chemical Corporation), RAVEN 1255 (manufactured by Columbian Chemicals Co., Inc.), REGAL 330R, 400R and 660R, and MOGUL L (all manufactured by Cabot Corporation), and Nipex 1601Q, Nipex 1701Q, Nipex 75, Printex 85, Printex 95, Printex 90, Printex 35 and Printex U (all manufactured by Orion Engineered Carbons LLC).

In this embodiment of the present invention, the pigment is not limited to the pigments described above, and other special colors such as orange pigments and green pigments can also be used. Further, a plurality of pigments may be combined. Moreover, in another embodiment, the aqueous ink composition of this embodiment of the present invention may be combined with a clear ink containing no pigment such as a primer or a coating, and used as an ink set. Any other pigment and/or dye can be used that is useful in modifying the color of the ink.

The weight concentration of a pigment (P) should be understood as the dry weight concentration of the active pigment, thus the effective concentration of the active pigment, not including e.g. any solvent or water.

### Organic Solvent (OS)

The term “organic solvent” can be understood as solvent with a carbon-based substance that is used to dissolve another substance or substances. Since an organic solvent is carbon-based, it has at least one carbon atom in its structure. The type of, organic solvent is not particularly limited. It is preferable that the organic solvent is water-soluble from the viewpoint of increasing the compatibility with respect to the water within the aqueous ink composition. As explained before, the term “water-soluble” can be understood as that the organic solvent is miscible with water at 23° C. (73° F.; 296 K; 533° R).

Examples of the water-soluble organic solvent include alcohols, polyhydric alcohols, amines, amides, glycol ethers, 1,2-alkanediols and the like. Only one type of the organic solvent may be used, or two or more types thereof may be used.

Examples of polyhydric alcohols described above include ethylene glycol, diethylene glycol, triethylene glycol, tetraethylene glycol, polyethylene glycol having the number of ethylene oxide groups of greater than or equal to 5, propylene glycol, dipropylene glycol, tripropylene glycol, polypropylene glycol having the number of propylene oxide groups of greater than or equal to 4, butylene glycol, hexanediol, pentanediol, glycerin, hexanetriol, thiodiglycol, and the like. Examples of amines described above include ethanol amine, diethanol amine, triethanol amine, N-methyl diethanol amine, N-ethyl diethanol amine, morpholine, N-ethyl morpholine, ethylene diamine, diethylene diamine, triethylene tetramine, tetraethylene pentamine, polyethylene imine, pentamethyl diethylene triamine, tetramethyl propylene diamine, and the like.

Examples of amides described above include formamide, N,N-dimethyl formamide, N,N-dimethyl acetamide, pyrolidone, urea and the like.

Examples of glycol ethers described above include ethylene glycol monoethyl ether, ethylene glycol monobutyl ether, diethylene glycol monoethyl ether, diethylene glycol monobutyl ether, triethylene glycol monobutyl ether, propylene glycol monopropyl ether, dipropylene glycol monomethyl ether, tripropylene glycol monomethyl ether, and the like.

Examples of 1,2-alkanediols include 1,2-propanediol 1,2-butanediol, 1,2-pentanediol, 1,2-hexanediol, 1,2-heptanediol, and the like.

Water-soluble organic solvents may be selected being a penetrant for improving permeability (wettability) of the ink into the substrate. A penetrant supports adjusting a dot diameter on the substrate and/or improves adhesion of the pigment to the substrate. Particular suitable penetrants include alkanediols and glycol ethers.

A preferred organic solvent is alkane-triol, preferably glycerol also known as glycerine or propane-1,2,3-triol. During single pass industrial inkjet printing the presence of a solvent with a low vapor pressure, such as for example glycerol, avoids irreversible drying out of the ink at the nozzle openings of the printhead thereby preventing droplet formation.

Another preferred organic solvent is an alkane diol, preferably 1,2 propane diol also known as a propylene glycol. During single pass industrial inkjet printing the presence of this solvent with a low vapour pressure avoids irreversible dry out of the ink at the nozzle openings of the printhead thereby preventing droplet formation.

Another preferred organic solvent is a glycol ether, more in particular an alkylene glycol alkyl ether, preferably diethylene glycol butyl ether as it was found to be a good penetrant.

In a preferred embodiment, the ink composition includes a mixture of organic solvents, said mixture preferably comprising an alkylene polyol together with a glycol ether.

In particular, the mixture comprises water-soluble organic solvents. The term “soluble” can be understood as that the respective first substance can be mixed with the respective second substance to form a stable homogeneous mixture, preferably at any concentrations and relative proportions.

Preferably the mixture of organic solvents comprises an alkylene polyol, preferably glycerol and 1,2 propane diol combined with an alkylene glycol alkyl ether, preferably diethylene glycol butyl ether (DEGMBE).

The total organic solvent(s) content is preferably present within the ink composition in amounts of 5-50 wt %, preferably 10-45 wt %, more preferably 15-45 wt %, even more preferably 17-40 wt %.

### Water (W)

The ink composition being “aqueous” has water present. The amount of water within the composition can be at least 50 wt.-% of the total weight of ink composition.

### Binder (B)

The ink composition of the present invention also contains “a polymeric binder”, also referred to herein as “a binder resin”. Typical binder resins for aqueous ink compositions include water soluble resins and resin microparticles (emulsions/latexes). Examples of types of resins that can be used as the resin microparticles include acrylic-based, styrene/acrylic-based, urethane-based, styrene/butadiene-based, vinyl chloride-based, vinylacetate-based (possibly partially or fully hydrolysed), polyester-based, and polyolefin-based resins. The binder resins aid in achieving a stable jetting process, adhesion of the ink to the substrate, chemical and/or mechanical resistance of the final ink layer and can thus improve image quality. Commercial examples of polymeric binders (B) include Joncryl J8050E (BASF), Lubrijet T340 (Lubrizol), Neocryl D2101 (DSM).

It has now also been found that binders can be used to improve shelf life and prolong surfactant functionality over time.

The polymeric binder can be chosen from an anionic polymeric binder, a cationic polymeric binder or a non-ionic polymeric binder. In a preferred embodiment, polymeric binder is an acrylic, vinyl, styrene, olefinic or polyurethane based polymeric binder, preferably an acrylic-based polymer. Surprisingly, these binders could avoid surfactant hydrolysis and cause the ink composition to have an improved shelf life.

The polymeric binder is preferably included so as to have a dry weight concentration within the ink composition (IC) between 0.2-10 wt %, preferably between 0.5-10 wt %, more preferably between 0.7-7 wt %, most preferably between 1-5 wt %.

The weight concentration of a polymeric binder (B) should be understood as the dry weight concentration, thus the effective concentration of the binder, not including e.g. any solvent or water.

It is noted that, the polymeric binder can be included in a dissolved state, as microparticles: an emulsion polymer or dispersion polymer, such as an aqueous acrylic latex polymer. In that case the polymeric binder (B) is a mixture comprising the (pure) polymer and a carrier, such as a carrier liquid like water.

The weight ratio of the first surfactant (S1)/polymeric binder (B) is then understood as the dry weight of the first surfactant over the dry weight of the polymeric binder (being the effective binder concentration).

During the manufacturing of the composition, the weight ratio of the first surfactant (S1)/polymeric binder (B) (in particular present as an emulsion polymer or dispersion polymer) should be 0.22 or higher, preferably 0.25 or higher, more preferably 0.3 or higher. This way, one can provide excellent ink substrate wetting and very low levels of mottle for overlays of multiple process colors during fast industrial single pass printing and achieve prolonged shelf-life stability.

In a preferred embodiment, the polymeric binder (B) comprises a mixture of a (solid) acrylic polymer and a carrier. More preferably the polymeric binder (B) is an aqueous acrylic emulsion polymer. In an embodiment, the polymeric binder is a styrene acrylic dispersion.

The binder(s) are present in an amount to respect the dry weight ratio of first surfactant (S1)/polymeric binder (B) to be 0.22 or higher.

The binders are typically present in an amount of at least 0.2 wt %, more preferably in an amount of between about 0.2 wt % and about 10 wt %, more preferably in an amount of between about 0.7 wt and about 7 wt %, more preferably in an amount of between about 1 wt and about 5 wt %, such as present in an amount of about 1 wt % or 3 wt %. This way, stabilization of the surfactant can be provided while improving the shelf life of the ink.

### First Surfactant (S1)

Surfactants are known to have an effect on the surface tension of a liquid. Hence, these can be used to achieve a desired wetting performance of the ink on the substrate. Namely, surfactants can be used to reduce the surface tension of water-based inks to reduce its mottle tendency and make the ink spread out on the substrate. However, when using silicone surfactants, the functionality thereof may be lost due to the hydrolysis which is even more profound in aqueous inks.

Silicone surfactants can have many designs. A siloxane surfactant is made of a (hydrophobic) siloxane backbone on which a (hydrophilic) sidechain is attached, optionally via a linker-group. The siloxane backbone is an inexpensive but highly hydrophobic oligomer. Further, a hydrophilic side chain(s) can be attached to the backbone. The combination of a hydrophobic and hydrophilic segment in the molecule makes them suitable as a surfactant.

In case of the ethoxylated siloxane surfactants, the balance between the size of the hydrophobic siloxane part versus the size of the hydrophilic polyethoxylene side chain(s) is believed to influence the ability of the surfactant to reduce the surface tension and improve the interaction of polar liquids (such as aqueous inks which mainly consist of water) with an apolar surface of a substrate such as a coated paper or polymeric film material. This aspect is often described by the hydrophilic-lipophilic balance (HLB) number of the surfactant.

Instead of ethoxylated siloxane surfactants, other side chain chemistry (e.g. with propoxylene units) may be used instead, which improves the shelf life of the ink but may be nefarious for the printing quality because propoxylene is less compatible with the aqueous medium of the ink than ethoxylenes, especially in fast single pass printing processes. The spreading and wetting properties of the ink will be worse than when using siloxane-based surfactants with shorter side chains.

The composition as described herein comprises at least one first surfactant (S1) being a silicone surfactant with a siloxane-backbone (BB), in particular comprising a structure which in pure form is trisiloxane-backbone, hence having 3 Si atoms and wherein a polyether side chain (SC) is linked to the siloxane backbone via a carbon chain linking group (L) with 2 to 4 carbon atoms.

Understandably, when the first surfactant is received from a supplier, minor variations thereof may be present in this component, the first surfactant is still to be added as received from a supplier in the desired amount and ratio as described earlier above.

More in particular, the most predominant structure of the first surfactant (S1) is represented by a structure according to formula I as described herein, the predominant structure is preferably present in an amount of at least 0.15 wt % based on the overall ink composition as measured via LCMS as described herein.

Notably, the trisiloxane backbone (BB) indicates that the first surfactant (S1) has 3 Si atoms. With other words, as for the Si atoms, a trisiloxane backbone has not more than 3 Si atoms, nor less than 3 Si atoms.

In said first surfactant (S1) the polyether side chain comprises 2 to 5, in particular at most 5 ethylene oxide units (EO). preferably 3 or 4 ethylene oxide units (EO). Hence, it is understood that at most 5 ethylene oxide units are within the side chain. By having a desired amount of EO units, in particular less than 6 EO units, it was found that improved ink properties could be achieved, in particular when the surfactant (S1)/the polymeric binder (B) ratio is respected. As said earlier, the first surfactant (S1) being a silicone surfactant with a siloxane-backbone (BB). Within the inkjet ink composition (IC), the first surfactant(S) has a weight concentration of at least 0.65 wt %.

The weight concentration (wt %) of the surfactants described herein should be understood as the dry weight concentration, thus the effective concentration of the surfactant, not including e.g. any solvent or water.

By inclusion of such surfactant, excellent ink substrate wetting and very low levels of mottle for overlays of multiple process colors during fast industrial single pass printing. Preferably, the first surfactant (S1) has a trisiloxane-structure represented by formula I

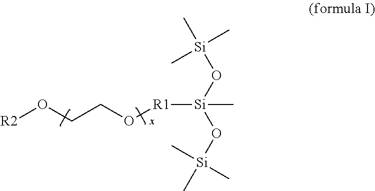

In the formula, R1 represents the carbon chain linking group (L) and has 2 to 4 carbon atoms, preferably 2 or 3 carbon atoms, more preferably 3 carbon atoms so as to provide structural and functional benefits to the surfactant structure with a proper balance between hydrophobic and hydrophilic characteristics of the surfactant.

Further, in the formula, R2 functions as an end group of the side chain. R2 represents a hydrogen atom or a hydrocarbon group having 1 to 4 carbon atoms, preferably a hydrogen atom. Further, as indicated formula I, the polyether side chain is composed of 2 to a maximum of 5 ethylene oxide units (EO), with a preference for 3 or 4 EO units, namely x is between 2 and 5, preferably 3 or 4. By choosing x as such, decent surfactant functionality could be given and while the surfactant could migrate rapidly through the ink composition to deliver its functionality were needed.

Preferably, R2 is a hydrogen atom and x is between 3 and 5, preferably 3 or 4. Furthermore, by including ethylene oxide units EO, one can improve interaction with the aqueous medium of the ink due to an improved solubility. More preferably, the carbon chain of R1 is a linear carbon chain, preferably a saturated linear chain, more preferably a saturated linear chain with 3 carbon atoms. This way, the side chain is more accessible to the aqueous medium and may cause an improved interaction between the pigment and the medium. Most preferably, R1 is a saturated linear carbon chain with 3 carbon atoms and wherein x is 4 and R2 is H.

Preferably, the ink composition comprises one or more surfactant structures in pure form according to formula I, wherein said one or more surfactant structures taken together are present in the overall ink composition in an amount of at least 0.2 wt %, more preferably at least 0.3 wt % as measured via LCMS analysis. Accordingly, the dry weight ratio of these one or more structure surfactants according to formula I to the binder (B) ratio is 0.05 or higher, preferably 0.1 or higher, more preferably 0.17 or higher, even more preferably 0.22 or higher.

Preferably, as seen within the overall ink composition, the ink composition comprises at least one or more surfactant structures which in pure form meet the requirements of formula I, wherein x is 4 and R1 is a linear carbon chain with 2 to at most 4 carbon atoms, preferably 2 or 3 carbon atoms, more preferably 3 carbon atoms, R2 is H and wherein these pure form structures are present in the ink in an amount of at least 0.15 wt % as determined by LCMS.

Furthermore, the total molecular weight of the surfactant will impact the diffusion speed of the surfactant molecule and since small molecules diffuse faster through the liquid ink they will be able to rapidly move to the interface between the polar liquid and less polar or apolar substrate (as long as the surfactant has a good solubility in the migrate medium) and thereby reduce the surface energy at the interface. Note that two surfactants with a similar HLB value might have a completely different molecular mass e.g. a trisiloxane with a relative short polyethoxylene side chain versus a pentasiloxane with a longer polyethoxylene side chain. A high mobility and fast diffusion of the surfactant in the liquid phase, of e.g. a trisiloxane with a relative short polyethoxylene side chain is highly preferred above e.g. a pentasiloxane with a longer polyethoxylene side chain, specifically for high speed industrial single pass printing processes because the contact angle between the ink droplet and medium has to be reduced sufficiently before the ink is dry.

Preferably, the first surfactant has a molecular weight lower than 600 g/mol, more preferably lower than 530 g/mol, most preferably lower than 500 g/mol, such as 457 g/mol. This way, the surface energy of a substrate to print on can be modified quickly since the surfactant can move quickly through the ink composition and deliver a desired wettability performance in a rapid manner. In an embodiment, the composition comprises the first silicone surfactant as described herein and a second silicone surfactant (S′), wherein the first silicone surfactant has a molecular weight lower than 600 g/mol, more preferably lower than 530 g/mol, most preferably lower than 500 g/mol, such as 457 g/mol and the second silicone surfactant has a molecular weight higher than 540 g/mol, preferably between 600 g/mol and 1500 g/mol, more preferably between 600 g/mol and 1000 g/mol. This way, one can further improve the image print quality. The second silicone surfactant may have one or more features as described further below.

### Optional Co-Surfactants (S′ or S2)

In addition to the first surfactant as described above, a second surfactant may be included in the ink composition. Said second surfactant being different than the first surfactant. In an embodiment, the second surfactant is a non-siloxane surfactant (S2) or a siloxane surfactant (S′) different from the first surfactant. The siloxane surfactant (S′) is also referred to as silicone surfactant (S′).

The second non-siloxane surfactant (S2) can improve the jettability and image print quality even further, in combination with surfactant (S1). An example of a second non-siloxane surfactant (S2) is an “ethoxylated acetylenic diol”, such as an ethoxylated 2,4,7,9-tetramethyl 5 decyn-4,7-diol (commercially available as e.g. Surfynol 420, Surfynol 440 and Surfynol 465, all available from Evonik) and is believed to be represented by:

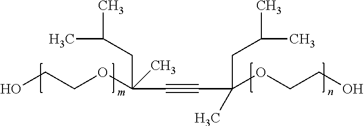

Alternatively, ethoxylated acetylenic diols based on a dodecyne backbone can be used, which are commercially available as Dynol 604 and Dynol 607, all available from Evonik. A preferred example of a non-siloxane surfactant (S2) is Surfynol 465 (Evonik).

In an embodiment, the composition comprises the first silicone surfactant (S1) and an additional second siloxane surfactant (S′) that is different than the first silicone surfactant. The terms silicone surfactant and siloxane surfactant can be used interchangeably herein. In an embodiment, the first silicone surfactant has a molecular weight lower than 600 g/mol, more preferably lower than 530 g/mol, most preferably lower than 500 g/mol, such as 457 g/mol and the second silicone surfactant (S′) has a molecular weight higher than 540 g/mol, preferably between 600 g/mol and 1500 g/mol, more preferably between 600 g/mol and 1000 g/mol.

In some embodiments, the molecular weight (Mw) of the second silicone surfactant (S′) may be such that the molecular weight of the second silicone surfactant (S′) is higher than the molecular weight of the first silicone surfactant (S1). This way, print quality can be further improved.

Examples of the additional second silicone surfactants (S′) are silicone surfactants which contain a larger silicone backbone than S1, i.e. pentasiloxane or an even larger backbone, such as BYK-348 (Byk Chemicals) and SILFACE SAG503A (Shin Etsu Chemicals), and/or contain ethoxylene/propoxylene oxide monomer blend in the water soluble tail of the surfactant, such as Tegowet KL245 (Evonik) and/or contain a significantly longer water soluble tail of the surfactant (x>5 in formula I) such as Dowsil 67, Dowsil 501W, Dowsil 502W (DOW), Tegowet 240, Tegowet 280 (EVONIK), BYK 3450, BYK 3451 (Byk Chemicals).

### Other Components, Additives, and the Like

In the inkjet printing ink, various known additives, for example, biocides, polysaccharides, a viscosity adjuster, a film forming agent, a pH adjuster and the like can be suitably selected and used in addition to the components described above, as necessary, according to the object of improving all performances.

Suitable biocides for the pigmented inkjet ink include sodium dehydroacetate, 2-phenoxyethanol, sodium benzoate, sodium pyridinethion-1-oxide, ethyl p-hydroxybenzoate, 2-methyl-1,2-thiazol-3-one and 1,2-benzisothiazolin-3-one and salts thereof. A biocide can be added in an amount of 0.001 to 3 wt-%, more preferably 0.01 to 1.00 wt-%, each based on the total weight of the pigmented inkjet ink. Defoamers or anti-foaming agents may also be added. A pH adjuster can be included in the composition so as to keep pH levels in the range of 3-11, more preferably in the range of 4-10, even more preferably in the range of 7-9.

It was found that the ink composition as described her-in could achieve high print qualities on substrates which are typically challenging to print on. More in particular, the ink achieved good results when printing on both coated and uncoated paper liners intended to be used for manufacturing corrugated board.

### Process to Manufacture the Ink Composition

The ink composition can be made with the following steps:
providing a mixture with a pigment (P), an organic solvent (OS) and water (W);
adding a polymeric binder (B) and a first surfactant (S1) to the mixture.

The first surfactant being a silicone surfactant with a siloxane-backbone (BB) comprising 3 Si atoms, more in particular a trisiloxane-backbone (BB), hence having 3 Si atoms, and wherein a polyether side chain (SC) is linked to the siloxane backbone via a carbon chain linking group (L) with 2 to 4 carbon atoms, said polyether side chain comprising 2 to 5 ethylene oxide units (EO), in particular at most 5 ethylene oxide units (EO). The first surfactant (S1) can have one or more of the preferred features as described above.

It is to be understood that the first surfactant (S1) is to be added respecting a dry weight concentration of at least 0.65 wt % based on the total weight of the composition. Further, the first surfactant (S1) and the polymeric binder (supra) are added such that the dry weight ratio of the first surfactant (S1)/polymeric binder (B) is 0.22 or higher, preferably 0.3 or higher.

During manufacturing, the first surfactant (S1) may be included within the mixture by addition of a surfactant as available on market respecting the dry weight concentrations as herein provided, wherein said first surfactant (S1) predominantly comprises pure structures according to the first surfactant (S1), in particular a structure according to formula I, and optional variations thereof or other components to a lesser extent. In this manner, it is preferred that the overall composition includes at least 0.15 wt % of pure structures according formula I.

The ink composition may further include a second siloxane surfactant (S1co) represented by formula Ico as shown below:

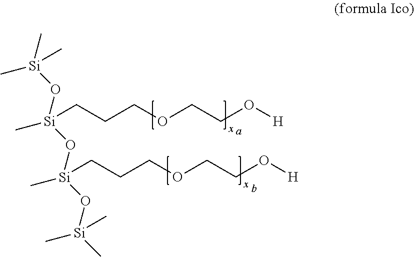

whereby
xₐ and x_{b} are independently, preferably both, chosen from an integer between 3-9, preferably 5-7, most preferably 6.

### Set for Inkjet Printing

The ink composition as described above can be used in a set for inkjet printing. The set, in addition to the ink composition, further comprises a pretreatment liquid (P) for forming a primer layer. The primer layer can, if needed, further improve ink receptibility of a substrate and control the ink spreading or limit feathering and intercolor bleeding. The pretreatment liquid (P) may comprise at least one aggregating agent of the group: multivalent metal salt, organic acid and/or cationic polymer.

In a particular embodiment, the pretreatment liquid (P) comprises a primer composition (PC) for forming a primer layer, on a substrate to be printed. Said composition comprises:
a first polymeric binder component A having a first polar contribution pc1 less than 20%;
a second component B comprising an inorganic particle B′ and/or a second polymeric binder component B″; wherein said polymeric binder component B″ has a second polar contribution pc2 equal or higher than 20%; wherein the amounts of A, B′ and/or B″, based on the dry weight of the composition, are as such that when present B′/(A+B″+B′) is smaller than 15%. The first polar contribution pc1 and second polar contribution pc2 are determined by using the Owens-Wendt-Rabel-Kaelble method with a 6 gsm dry layer of components A and B respectively. This excessively thick polymer layer of 6 gsm is used to exclude any remaining influence of the material underneath the polymer film. The polar contribution is the contribution of the polar component to the total surface energy. For more details and benefits of the primer composition (PC), reference is made to Dutch patent application NL2030551A in the name of the Applicant, which is incorporated herein by reference. Preferably, the second polar contribution pc2 of the second component B, is more than 22%, more preferably more than 24%. Preferably, the dry weight ratio of A/(B′ and/or B″) is between 0.05 and 20, more preferably between 0.15 and 6.

The invention shall now be explained by way of some examples shown below. However, these are in no way to be understood as limiting.

### EXAMPLES

### Surfactants

According to analysis via Liquid Chromatography Mass Spectrometry (LC-MS) the inventors analyzed commercially available surfactants S1 and surfactants S′1-S′3.

| | Commercial | # of | | # of | Mw (g/mol) |
|---|---|---|---|---|---|
| Ref. | Name | Si atoms | # of EO | PO | (calculated) |
| S1 | Byk 347 | 3 | 4 | 0 | 457 g/mol |
| S′1 | Dowsil 502 | 3 | 9 | 0 | 676 g/mol |
| S′2 | Tegowet KL245 | 3 | 10 | 1 | 778 g/mol |
| S′3 | Tegowet 280 | 3-4 | 6-7 | 0 | 602 g/mol |
| S′4 | Byk 348 | 4 | more than 5 | / | / |

In the table above, the predominant fraction of the commercial composition is described. “# of EO” represents the amount of ethylene oxide units within the side chain.

Further, the “# of PO” represents the amount of propylene oxide units within the side chain.

The surfactants S1 and surfactants S′1-S′3 and S′4 shall be further discussed below.

S1 is a polyether-modified siloxane-based surfactant having a structure according to the formula I.

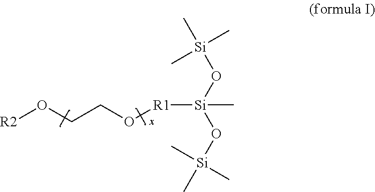

For S1, R1 therein is a saturated linear carbon chain with 3 carbon atoms and x is 4 (number of ethylene oxide units) and R2 is H.

S′1 is believed to be represented by:

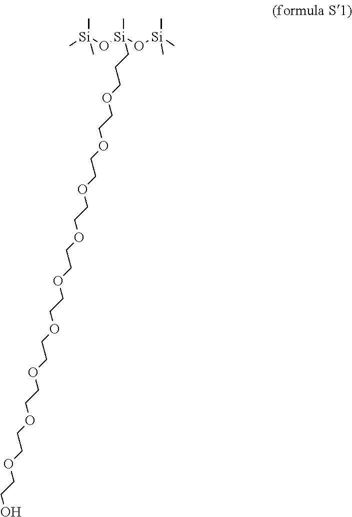 [SMILES: C[Si](C)(C)O[Si](C)(CCCOCCOCCOCCOCCOCCOCCOCCOCCOCCO)O[Si](C)(C)C]

S′1 has a longer side chain with 9 ethylene oxide units.

S′2 is believed to be represented by:

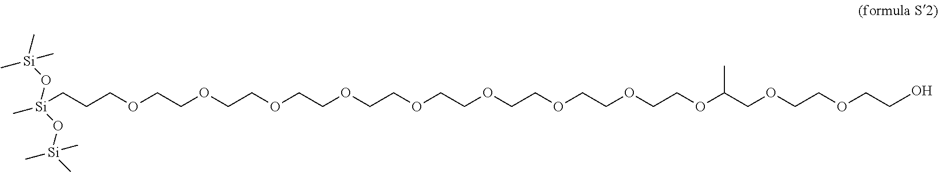 [SMILES: CC(COCCOCCO)OCCOCCOCCOCCOCCOCCOCCOCCOCCC[Si](C)(O[Si](C)(C)C)O[Si](C)(C)C]

S′2 also has a longer side chain in comparison with S1 and includes a propylene oxide unit resulting in a more bulky side chain.

S′3 is believed to be represented by a mixture mainly comprising:

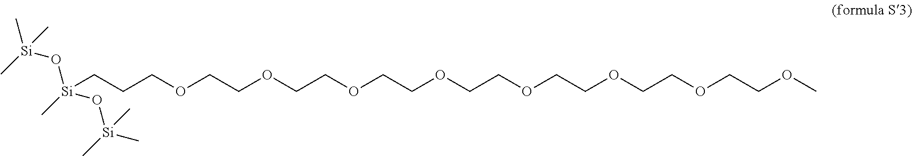

A longer and/or bulkier side chain may shield the siloxane backbone from hydrolysis but may not result in desired wetting. It was found that by combining a binder (B) with surfactant S1 and optionally one or more surfactant S′1-S′3, good print quality & good wetting could be achieved while a high shelf life was maintained.

In addition to the siloxane surfactants above, a non-siloxane surfactant (S2) can be included.

For S2, e.g. Surfynol 465 was used for achieving good jettability and S2 can be represented the formula II wherein m+n is between 4-12, m is 1 or more and n is 1 or more:

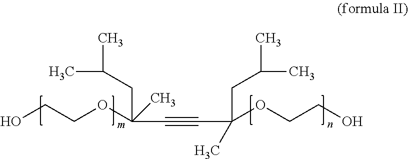

Surfynol 465 is believed to be represented by formula II.

Surfactant S′4 has been reviewed and has a relatively longer sidechain when compared with the first surfactant S1.

The surfactants have been tested in several ink compositions as shown in the tables below.

### Ink Compositions

The following aqueous ink compositions were tested. Herein, Y is short for yellow and C is short for Cyan.

TABLE 1

| | | Examples (wt %) | | | | | | | | | |
|---|---|---|---|---|---|---|---|---|---|---|---|
| | | I1 | I1 | I2 | I2 | I3 | I3 | I4 | I4 | I5 | I5 |
| Comment | Component | Y | C | Y | C | Y | C | Y | C | Y | C |
| Pigment (P) | APD1000 Pigment | 3.15 | | 3.15 | | 3.15 | | 3.15 | | 3.15 | |
| | Yellow 74 | | | | | | | | | | |
| | APD1000 Pigment Blue | | 3.25 | | 3.25 | | 3.25 | | 3.25 | | 3.25 |
| | 15:3 | | | | | | | | | | |
| Siloxane surfactant (S) | See S1 | 1.5 | 1.5 | 1.5 | 1.5 | 1 | 1 | 1.5 | 1.5 | 0.7 | 0.7 |
| Other siloxane | See S′1 | | | | | | | | | | |
| surfactant (S′) | See S′2 | | | | | | | | | | |
| | See S′3 | | | | | | | | | | |
| Second surfactant (S2) | See S2 | 0.95 | 0.95 | 0.95 | 0.95 | 0.95 | 0.95 | 0.95 | 0.95 | 0.95 | 0.95 |
| | (non-siloxane) | | | | | | | | | | |
| Binder (B) | B1 | 3 | 3 | | | 1 | 1 | 1 | 1 | 3 | 3 |
| | B2 | | | 3 | 3 | | | | | | |
| Organic Solvent (OS) | See OS1 | 19 | 19 | 19 | 19 | 24 | 24 | 22 | 22 | 20 | 20 |
| | See OS2 | 10 | 10 | 10 | 10 | 14 | 14 | 12 | 12 | 11 | 11 |
| | See OS3 | 1.5 | 1.5 | 1.5 | 1.5 | 1.5 | 1.5 | 1.5 | 1.5 | 1.5 | 1.5 |
| Water (W) | | rest | rest | rest | rest | rest | rest | rest | rest | rest | rest |
| S1/B | | 0.5 | 0.5 | 0.5 | 0.5 | 1 | 1 | 1.5 | 1.5 | 0.23 | 0.23 |

TABLE 2

| | | Comparatives (wt %) | | | | | | | |
|---|---|---|---|---|---|---|---|---|---|
| | | I6 | I6 | I7 | I7 | I8 | I8 | I9 | I9 |
| Comment | Component | Y | C | Y | C | Y | C | Y | C |
| Pigment (P) | APD1000 Pigment | 3.15 | | 3.15 | | 3.15 | | 3.15 | |
| | Yellow 74 | | | | | | | | |
| | APD1000 Pigment Blue | | 3.25 | | 3.25 | | 3.25 | | 3.25 |
| | 15:3 | | | | | | | | |
| Siloxane surfactant (S) | See S1 | 0.5 | 0.5 | 1.5 | 1.5 | 0.5 | 0.5 | 0.5 | 0.5 |
| Other siloxane | S1 | | | | | | | | |
| surfactant (S′) | S′2 | | | | | | | | |
| | S′3 | | | | | | | | |
| Second surfactant (S2) | See S2 | 0.95 | 0.95 | 0.95 | 0.95 | 0.95 | 0.95 | 0.95 | 0.95 |
| | (non-siloxane) | | | | | | | | |
| Binder (B) | B1 | | | | | 1 | 1 | 3 | 3 |
| | B2 | | | | | | | | |
| Organic Solvent (OS) | See OS1 | 24 | 25 | 21 | 23 | 24 | 24 | 20 | 20 |
| | See OS2 | 15 | 15 | 12 | 13 | 14 | 14 | 11 | 11 |
| | See OS3 | 1.5 | 1.5 | 1.5 | 1.5 | 1.5 | 1.5 | 1.5 | 1.5 |
| Water (W) | | rest | rest | rest | rest | rest | rest | rest | rest |
| S1/B | | — | — | — | — | 0.5 | 0.5 | 0.17 | 0.17 |

TABLE 3

| | | Comparatives (wt %) | | | | | | | | | |
|---|---|---|---|---|---|---|---|---|---|---|---|
| | | I10 | I10 | I11 | I11 | I12 | I12 | I13 | I13 | I14 | I14 |
| Comment | Component | Y | C | Y | C | Y | C | Y | C | Y | C |
| Pigment (P) | APD1000 | 3.15 | | 3.15 | | 3.15 | | 3.15 | | 3.15 | |
| | Pigment Yellow 74 | | | | | | | | | | |
| | APD1000 | | 3.25 | | 3.25 | | 3.25 | | 3.25 | | 3.25 |
| | Pigment Blue 15:3 | | | | | | | | | | |
| Siloxane surfactant (S) | See S1 | | | | | | | | | | |
| Other siloxane surfactant (S′) | See S′1 | 1.5 | 1.5 | | | | | 1.5 | 1.5 | | |
| | See S′2 | | | 1.5 | 1.5 | | | | | 1.5 | 1.5 |
| | See S′3 | | | | | 1.5 | 1.5 | | | | |
| Second surfactant (S2) | See S2 | 0.95 | 0.95 | 0.95 | 0.95 | 0.95 | 0.95 | 0.95 | 0.95 | 0.95 | 0.95 |
| | (non-siloxane) | | | | | | | | | | |
| Binder (B) | B1 | | | | | 3 | 3 | 3 | 3 | 3 | 3 |
| | B2 | | | | | | | | | | |
| Organic Solvent (OS) | See OS1 | 21 | 22 | 21 | 21 | 21 | 21 | 19 | 19 | 18 | 18 |
| | See OS2 | 12 | 13 | 12 | 12 | 12 | 12 | 11 | 11 | 9 | 9 |
| | See OS3 | 1.5 | 1.5 | 1.5 | 1.5 | 1.5 | 1.5 | 1.5 | 1.5 | 1.5 | 1.5 |
| Water (W) | | rest | rest | rest | rest | rest | rest | rest | rest | rest | rest |
| S1/B | | — | — | — | — | — | — | — | — | — | — |

The pigment dispersions used were APD1000 Pigment Yellow 74 and Blue 15:3, both available from Fujifilm. The wt % of the pigment is the effective active pigment concentration.

The formulas S1, S′1-S′3 and S2 for the surfactants are shown above. The wt % values of the surfactant components represent the values of the concentrations of the surfactant components as available on market (which may include structural variations in a lesser extent as a result of impurity). The S1, S′1-S′3 and S2 structures itself represent the pure structures which are most predominantly present within the surfactant components as available on market.

Binder B1 represents Joncryl J8050E and binder B2 represents Neocryl D2101.

The wt % values of the binders B1 and B2 are the effective real binder concentrations, thus the dry concentration (dry wt %). The wt % values of the surfactants S1, S′, and S2 are the effective concentrations, thus the dry concentration (dry wt %).

As for the organic solvent, OS1, OS2 and OS3 respectively represent glycerol, 1,2 propane diol and diethylene glycol butyl ether.

In table 1, inventive samples are shown. Here, a first siloxane surfactant S1 (complying with formula I) was included within an inkjet composition together with a binder B. In these examples, the first siloxane surfactant has a dry weight concentration of at least 0.65 wt % within the inkjet ink composition and the dry weight ratio of the first surfactant S1/polymeric binder B is 0.22, preferably 0.3 or higher.

In table 2, comparative samples are shown. Here, the first siloxane surfactant S1 is included but in low concentrations (0.5 wt %) or in a higher concentration (1.5 wt %) but not in combination with a polymeric binder B.

In table 3, comparative samples are shown. Here, the first siloxane surfactant S1 according to formula I can be compared with other silicone surfactants, such as Dowsil 502, Tegowet KL245, Tegowet 280 (see e.g. examples I12-I14). These can also be referred to as wetting agents.

### Evaluation

The test samples above were evaluated. These evaluations are shown below in table 4 from which it is derivable that examples I2-I5 achieve good image quality in terms of mottle and no intercolor wetting issues for cyan on yellow ink after 7 days ageing at 60° C. In contrast, examples I6-I14 show non-acceptable mottle at the start, and/or a non-acceptable mottle after ageing 7 d 60° C.

For I6 and I7, no binder B is present to stabilize the composition and I6 has a S1 surfactant concentration which is not at least 0.65 wt %. I7 is the only comparative with a good mottle behavior at the start but shows a strong degradation of the mottle and linewidth change after ageing.

For I8, this comparative has a binder B but the surfactant S1 concentration is not at least 0.65 wt %.

For I9, the surfactant S1/binder ratio is not 0.22 or higher. The other comparative examples (I10-I14) demonstrate that a poor choice of surfactant does not provide acceptable image quality even before ink aging although the ink degradation might be acceptable.

TABLE 4

| | Mottle | Mottle | Line width | |
|---|---|---|---|---|
| | 60% Y + | 60% Y +60% C | change | Comparative I or |
| | 60% C | after 7 days 60° C. | evaluation | Example I |
| I1 | B | B | B | E |
| I2 | B | B | B | E |
| I3 | B | B | A | E |
| I4 | A | B | A | E |
| I5 | B | B | A | E |
| I6 | C | D | B | C |
| I7 | A | C | C | C |
| I8 | C | D | A | C |
| I9 | C | C | B | C |
| I10 | C | D | C | C |
| I11 | D | D | B | C |
| I12 | C | C | A | C |
| I13 | C | C | B | C |
| I14 | D | D | B | C |

From Table 4, it can be derived that the printing capabilities of inventive samples I1-I5 are high quality (acceptable mottle) and these are maintained over a prolonged period, thus indicating an improved shelf life. In contrast, the comparative samples I6-I14 did not achieve a good quality or if a good print quality was obtained (see I7), said print quality was not maintained over time.

### Evaluation Criteria

An evaluation of the image quality after printing has been made in terms of mottle tendency and width of fine cyan lines with yellow printed underneath.

Mottled images can appear granular, caused by a failure of the ink to flow out smoothly (ie. wetting). The printed color areas typically have a noticeable unevenness in print density with minor-to-moderate shade or hue variations. Hence, mottle causes non uniformity in the image and is typically undesired.

To run the tests, yellow+cyan overlay images with a 600 dpi Kyocera KJ4B at a speed of 1 m/see on a coated paper substrate (Metsaboard WKL Pro 130 gsm). In the same print run yellow and cyan images were printed consecutively. Directly after the cyan print station infrared drying was applied to ensure drying of the ink layer and remove most of the liquids in the ink layer. The infrared drying station, placed after every color printing unit, is equipped with 4×1330W lamps (1.3 μm wavelength) each emitting 52 W/cm.

For assessing the mottle tendency of the different inks a 60% screened yellow image was printed with 60% screened cyan image on top. The following abbreviations were used for the evaluation of mottle tendency:
A. Excellent image quality with homogeneous density over the ink color patch
B. Good image quality in terms of mottle and no wetting issues for cyan on yellow ink
C. Non-acceptable mottle but no de-wetting of cyan on yellow ink
D. Non-acceptable mottle and insufficient wetting of cyan on yellow ink

Intercolor bleeding can occur when two or more different colored aqueous inks are printed with ink jet printing. For evaluating the intercolor bleeding a 3pxl cyan line was printed on top of a 60% screened yellow image underneath. Note that some amount of intercolor bleeding is (almost) unavoidable for aqueous inks but it has been found that this bleeding may both decrease or increase significantly for an aged ink.

$$This linewidth change : ‘ x ’ = ( 3 pxl {line [ C ]}_{fresh} on 60 {\% [ Y ]}_{fresh} ) / ( 3 pxl {line [ C ]}_{aged 7 d at 60 ° C .} on 60 {\% [ Y ]}_{fresh} + ) * 100 \% .$$

The width of the 3pxl cyan line was measured with a PIAS™-II Personal Image Analysis System (Quality Engineering Associates) for the infrared dried prints. The following abbreviations were used for the evaluation of linewidth change:
A. x=90%-110% and only limited ink deterioration by accelerated ageing for 7 days at 60° C.
B. x=80%-90% or 110-120% and acceptable ink deterioration by accelerated ageing for 7 days at 60° C.
C. x<80% or >120% and non-acceptable ink deterioration by accelerated ageing for 7 days at 60°

It was found that the ink compositions I1-I5 showed no or only limited ink deterioration and/or acceptable ink deterioration when subjected to accelerated ageing for 7 days at 60°. In contrast, the comparative samples I6-I14 did not achieve a good quality or if a good print quality was obtained (see I7), said print quality was not maintained over time.

The skilled person will appreciate based on the above description and examples that the invention can be embodied in different ways and on the basis of different principles. The invention is not limited to the above-described embodiments and/or examples as are purely illustrative and serve only to increase understanding of the invention. The invention will not therefore be limited to the embodiments described herein but is defined in the appended claims.

1. An aqueous inkjet ink composition for forming an image on a substrate, said composition comprising:
a pigment, an organic solvent and further comprises:
a polymeric binder,
at least one first surfactant, said first surfactant being a silicone surfactant with a trisiloxane-backbone with 3 Si atoms, and wherein
a polyether side chain is linked to the siloxane backbone via a carbon chain linking group with 2 to 4 carbon atoms; wherein the polyether side chain comprises 2 to at most 5, preferably 3 or 4 ethylene oxide units;
wherein said first surfactant has a weight concentration of at least 0.65 wt %, and wherein a dry weight ratio of the first surfactant/the polymeric binder is 0.22 or higher, preferably 0.25 or higher, more preferably 0.3 or higher.

2. The ink composition according to claim 1, wherein the first surfactant having a trisiloxane-structure represented by formula I: 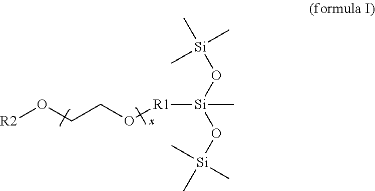
wherein R1 represents the carbon chain linking group and has 2 to 4 carbon atoms,
preferably 2 or 3 carbon atoms, more preferably 3 carbon atoms;
wherein R2 represents
a hydrogen atom or
a hydrocarbon group having 1 to 4 carbon atoms, preferably a hydrogen atom; and
wherein x is between 3 and 5, preferably 3 or 4.

3. The ink composition according to claim 1, wherein the carbon chain linking group is a linear carbon chain, preferably a saturated linear chain with 3 carbon atoms.

4. The ink composition according to claim 2, wherein the carbon chain linking group is a saturated linear carbon chain with 3 carbon atoms and wherein x is 4 and R2 is a hydrogen atom.

5. The ink composition according to claim 1, wherein the first surfactant has a molecular weight lower than 600 g/mol, more preferably lower than 530 g/mol, even more preferably lower than 500 g/mol.

6. The ink composition according to claim 1, wherein the polymeric binder comprises an anionic polymeric binder, a cationic polymeric binder or a non-ionic polymeric binder.

7. The ink composition according to claim 1, wherein the polymeric binder comprises an acrylic, vinyl, styrene, olefinic or polyurethane based polymeric binder, preferably an acrylic-based polymer.

8. The ink composition according to claim 1, wherein the polymeric binder has a dry weight concentration within the ink composition between 0.2-10 wt %, preferably 0.7-7 wt %, more preferably 1-5 wt %.

9. The ink composition according to claim 1, wherein the composition comprises an additional silicone surfactant which is different from the first surfactant.

10. The ink composition according to claim 9, wherein the additional surfactant is a silicone surfactant with
a siloxane-backbone comprising 3-5 Si atoms and
wherein a polyether side chain is linked to the siloxane backbone via a carbon chain linking group with 2 to 4 carbon atoms; wherein the polyether side chain comprises 6-15 ethylene oxide units, preferably 7-14 ethylene oxide units.

11. The ink composition according to claim 9, previous two claims, wherein the first surfactant has a molecular weight of lower than 600 g/mol and wherein the additional surfactant has a molecular weight higher than 540 g/mol, preferably between 600 and 1500 g/mol, more preferably between 600 and 1000 g/mol.

12. The ink composition according to claim 1, wherein the composition further comprises a non-siloxane surfactant.

13. The ink composition according to claim 12, wherein the non-siloxane surfactant is an ethoxylated surfactant, more preferably an ethoxylated acetylenic diol, even more preferably an ethoxylated acetylenic diol with a backbone of 10 or 12 carbons, most preferably represented by formula II, 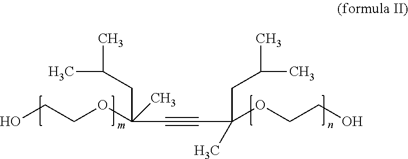
wherein m is 1 or more and n is 1 or more, and wherein m+n is 4 to 12.

14. The ink composition according to claim 1, wherein the composition is obtained by including the first surfactant and optional additional surfactants with a weight ratio of first surfactant/total amount of surfactants that is about and between 0.1-1.0, preferably about and between 0.2-1.0, more preferably about and between 0.2-0.7.

15. The ink composition according to claim 1, wherein the first surfactant has a weight concentration within the ink composition of at most 2 wt %, preferably at most 1.8 wt %, more preferably at most 1.5 wt %.

16. The ink composition according to claim 1, wherein the ink composition has a static surface tension below 26 mN·m as measured at 10s by bubble pressure tensiometer.

17. The ink composition according to claim 1, wherein the organic solvent comprises a water-soluble solvent having a boiling point of 180° C. or higher, preferably chosen from glycerol, 1,2 propane diol, diethylene glycol butyl ether or a combination thereof.

18. A use of the ink composition according to claim 1, to print on a corrugated board, preferably a coated corrugated board, or to print on a polymeric film, such as a polypropylene, polyethylene, or polyethylene terephthalate film.

19. (canceled)

20. A process for manufacturing an ink composition, said process comprising the steps of:
providing a mixture with a pigment, an organic solvent and water;
adding a polymeric binder and a first surfactant to the mixture,
wherein the first surfactant has a weight concentration of at least 0.65 wt % and
wherein a dry weight ratio of the first surfactant/polymeric binder is 0.22 or higher;
said first surfactant being a silicone surfactant with a trisiloxane-backbone with 3 Si atoms and wherein a polyether side chain is linked to the siloxane backbone via a carbon chain linking group with 2 to 4 carbon atoms, said polyether side chain comprising 2 to at most 5 ethylene oxide units.

21. (canceled)

22. A set for inkjet printing, said set comprising:
the ink composition according to claim 1; and
a pretreatment liquid for forming a primer layer, preferably wherein the pretreatment liquid comprises at least one aggregating agent of the group: multivalent metal salt, organic acid and/or cationic polymer.

23. (canceled)

24. (canceled)
